(19) United States
(12) Patent Application Publication
(10) Pub. No.: US 2006/0105783 A1
(43) Pub. Date: May 18, 2006

(54) Guest amenity system and methods for using same

(76) Inventors: Timothy W. Giraldin, Ladera Ranch, CA (US); Patrick W. Giraldin, Ladera Ranch, CA (US); Regan E. Kelly, Laguna Niguel, CA (US)

Correspondence Address: DUCKOR SPRADLING METZGER, 401 WEST A STREET, SUITE 2400, SAN DIEGO, CA, 92101-7915, US

(21) Appl. No.: 10/991,237

(22) Filed: Nov. 16, 2004

(51) Int. Cl. H04Q 7/20

(52) U.S. Cl. 455/456.3

(57) ABSTRACT

A guest amenity system and method are disclosed, and include providing each one of at least some of the individuals of a group with a wireless enabled portable communicator having an identification tag with a unique identification tag identifier. At least one monitoring site is located within a defined environment where the individuals are located for sending and receiving signals to and from the tags as the individuals move within the defined environment. Location information for the individuals is determined in response to the monitoring sites. The location information about the group of individuals within the environment are communicated to at least one of the portable wireless communicators. Other amenity information is also communicated to the portable wireless communicators.

### CROSS-REFERENCES TO RELATED APPLICATIONS

The following U.S. patents are related to the present invention and are hereby incorporated by reference in their entirety: U.S. Pat. No. 6,424,264, titled “SYSTEM FOR REAL-TIME LOCATION OF PEOPLE,” issued Jul. 23, 2002 and U.S. Pat. No. 6,747,562, titled “IDENTIFICATION TAG FOR REAL-TIME LOCATION OF PEOPLE,” issued Jun. 8, 2004.

The following U.S. patent applications are related to the present invention and are hereby incorporated by reference in their entirety: U.S. patent application Ser. No. 09/992,668, titled “SYSTEM FOR REAL-TIME LOCATION OF PEOPLE,” filed Nov. 13, 2001; U.S. patent application Ser. No. 10/716,583, titled “MESSAGE COMMUNICATION SYSTEM AND METHOD,” filed Nov. 18, 2003; U.S. patent application Ser. No. 10/717,052, titled “CASHLESS SPENDING SYSTEM,” filed Nov. 18, 2003; U.S. patent application Ser. No. 10/716,802, titled “PERSON LOCATING CASHLESS SPENDING SYSTEM AND METHOD,” filed Nov. 18, 2003; U.S. patent application Ser. No. 10/716,691, titled “DATA ANALYSIS SYSTEM,” filed Nov. 18, 2003; and U.S. patent application Ser. No. 10/716,800, titled “ROUTE PLANNING SYSTEM,” filed Nov. 18, 2003.

The following U.S. provisional patent application is related to the present invention and is hereby incorporated by reference in its entirety: U.S. provisional patent application Ser. No. 60/618,728, titled “COMMUNITY LOCATION SYSTEM,” filed Oct. 14, 2004.

### FIELD OF THE INVENTION

The present invention relates generally to provide guest amenity systems and methods, and more particularly, to provide guest amenities including tracking in real time the location of individuals of a group within a defined environment such environment.

### BACKGROUND ART

There is no admission that the background art disclosed in this section legally constitutes prior art.

There have been a variety of different types and kinds of systems and methods for tracking a group of individuals in real time within a defined environment such as a theme or amusement park, a casino, a cruise ship, a department store, hotels, zoos, resorts, shopping malls, a residential community, or others. For example, reference may be made to U.S. Pat. No. 6,424,264, which is incorporated herein by reference in its entirety, and which describes radio frequency identification tags worn or otherwise carried by individuals of a group. Monitors communicate with each tag as it moves with the individual through the environment, and a computer or other means use the communication to determine the position of the tag in the environment. The system also uses strategically placed identification stations distributed within the environment for users to request that the system locate members of the user's group or obtain help in assisting lost individuals.

### BRIEF DESCRIPTION OF THE DRAWINGS

The features of this invention and the manner of attaining them will become apparent, and the invention itself will be best understood by reference to the following description of certain embodiments of the invention taken in conjunction with the accompanying drawings, wherein:

FIG. 1 is a diagrammatic view of the tracking a guest amenity system constructed in accordance with an embodiment of the present invention;

FIG. 2 is a front elevational view of the portable wireless communicator of the system of FIG. 1; and

FIGS. 3-38 are front elevational views of the portable wireless communicator of FIG. 2, showing various features and modes of operation of the system of FIG. 1.

### DETAILED DESCRIPTION OF CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of the embodiments of the system, components and methods of certain embodiments of the present inventions, as represented in the drawings, is not intended to limit the scope of the invention, as claimed, but is merely representative of one or more of the embodiments of the invention.

A guest amenity system and method are disclosed, and include providing each one of at least some of the individuals of a group with a wireless enabled portable communicator having an identification tag with a unique identification tag identifier. At least one monitoring site is located within a defined environment where the individuals are located for sending and receiving signals to and from the tags as the individuals move within the defined environment. Location information for the individuals is determined in response to the monitoring sites. The location information about the group of individuals within the environment are communicated to at least one of the portable wireless communicators. Other amenity information is also communicated to the portable wireless communicators.

According to certain embodiments of the present invention, the system provides guest amenities including tracking in real time the location of a group of individuals within the defined environment and for providing information to individuals of the group about the location of any other individuals of the group. The system of the disclosed embodiments includes a portable wireless communicator being adapted to be carried or worn by the individuals of the group and having an identification tag incorporated therewith for providing location information via a monitoring site, and a host computer. As disclosed, the portable wireless communicator further includes a wireless network connection for enabling bidirectional communications via the communicator for enabling individuals of the group to view location information about his or her group dispersed about the environment as well as to provide to the individuals other guest amenity services.

According to still other embodiments of the present invention, there is provided a method for providing guest amenities, including the tracking in real-time the location of the group of individuals within a defined environment by providing at least some of the members of the group with a portable wireless communicator having an identification tag and a wireless network connection for enabling bidirectional communications via the communicator. Location data about the group of individuals in the environment is determined from the location of the tags and a host computer is used for storing identification tag identifiers with the identity and location of each group of individuals. The location information about the group of individuals in the environment is communicated from the host computer to the portable wireless communicator via the wireless network connection.

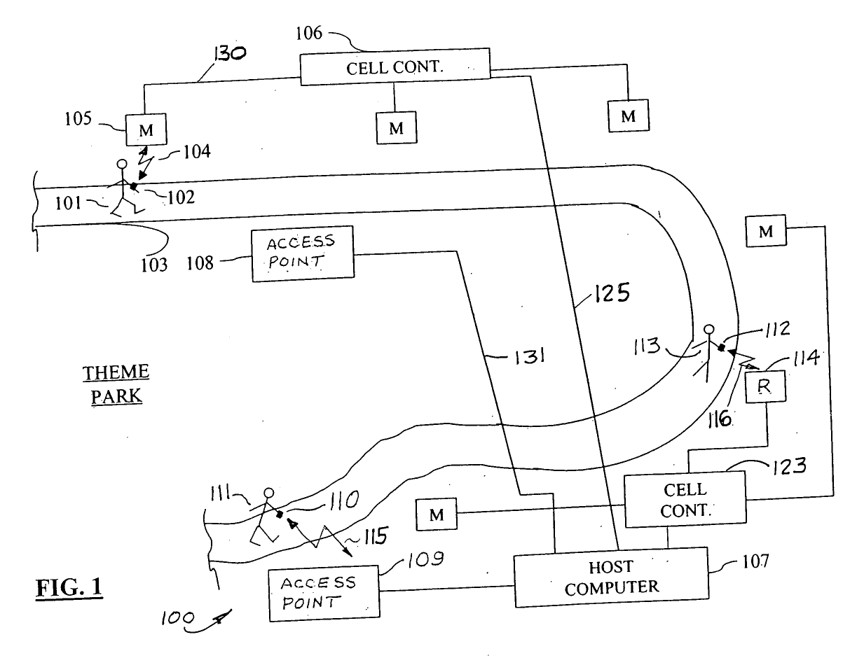

Referring now to the drawings, and more particularly to FIG. 1 thereof, there is shown a guest amenity system 100, which is constructed according to an embodiment of the invention. The system 100 may be used by a plurality or group of individuals such as individuals 101, 111, and 113 forming a group of individuals that wish to track each other's location within a defined environment, such as an amusement or theme park. However, it is to be understood that the system 100 may also be employed in a variety of different types and kinds of environments such as casinos, cruise ships, department stores, residential communities, hotels, zoos, resorts, shopping malls, and others.

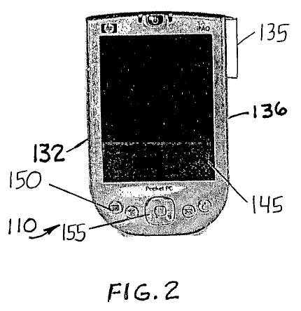

Each of the individuals such as the individual 101 of the group is provided with a portable wireless communicator such as the communicator 102. Similarly, the individual 111 has a communicator 110, and the individual 113 has a communicator 112. The wireless enabled communicators 102, 110 and 112 are similar to one another, and only communicator 110 will now be described in greater detail and is shown in FIG. 2.

Each portable wireless communicator such as the communicator 110 has incorporated therewith a long range identification tag 135 (FIG. 2) for providing location data. The communicator 110 includes a wireless network connection (not shown) for enabling bidirectional communications to a host computer 107. The long range identification tag 135 incorporates means, not shown, for receiving a radio signal such as radio signal 104 by the communicator 102, and for responding to that signal with a radio signal, for example as indicated at 104, that includes a long range identification tag identifier. The long range tag identifier is correlated to the identity of the individual such as individual 101, 111 or 113, and the group with which the individual is a member. For a more detailed description of a suitable tag, reference may be made to U.S. Pat. No. 6,747,562, although other tags and identification devices may also be employed for certain applications.

The system 100 further includes one or more monitoring sites such as a monitoring site 105 which may contain an antenna (not shown) and other associated radio electronics (not shown) for sending wireless signals, such as indicated at 104, to a long range identification tag of the communicator 102 and receiving a wireless signal as indicated at 104 from the long range identification tag of the communicator 102, the long range tag identifier.

One or more cell controllers such as cell controller 106 may be connected to the monitoring sites such as monitoring site 105. The cell controllers such as a cell controller 106 control the operation of the monitoring site and perform other operations of the system 100. Among other tasks, the host computer 107 controls the cell controller such as the cell controller 106.

In order to determine positional information for an individual such as the individual 101, the host computer 107 may receive the long range tag identifier for the individual of the group to be positionally determined within the defined environment. The host computer 107 may determine the location of the individuals responsive to the information received from the monitoring sites in a variety of locating techniques. For example, reference may be made to U.S. Pat. No. 6,424,264 for one such technique.

The long range identification tag of the portable wireless communicator 102 held by individual 101, responds by transmitting a return signal containing the long range tag identifier. In one embodiment, the long range identification tags may receive the radio signal at one frequency and the signal is returned by the transmitter in the tag at a different frequency.

The monitoring sites receive the return signal which may be sent to the cell controller 106, which, in turn, may calculate a tag to antenna distance for each tag based on the time elapsed between sending the signal from the antenna and receiving a return signal from the long range identification tag. In an alternative embodiment, tag to antenna distance is calculated at the host computer 107. Cell controllers with monitoring sites and antennae are well known in the art and are available commercially such as the “local positioning system (LPS) cell controller sold by Pinpoint Corporation, having a place of business in Billerica, Mass. Also, according to other embodiments, the cell controllers may be omitted.

Cell controllers such as cell controller 106 may send tag to antenna distance information to the host computer 107 which may compute the location of the long range identification tag having the specified long range tag identifier in the environment. The host computer 107 may determine, or otherwise store, location information about the individuals in the environment from the tag to antenna distance, or by means of other suitable location techniques. The host computer 107 may store the long range tag identifiers along with the identity and location of individuals of each group.

As described hereinabove, the portable wireless communicators, such as communicator 102, also incorporate a wireless network connection (not shown) for enabling bidirectional communications via the portable wireless communicators. The portable wireless communicators connect to a wireless network connection may, for example, use WI-FI wireless networking technology, or other suitable wireless networking technologies such as 802.11b, 802.11g, or even cellular radio network technology for certain applications, as well as others.

In one embodiment of the present invention, the system 100 includes one or more access points such as access points 108 and 109 which may provide wireless Ethernet access over a WI-FI network or other network between the plurality of portable wireless communicators operating within the environment and the host computer 107. The plurality of access points may be strategically dispersed throughout the environment to provide a wide area of wireless network coverage to the wireless enabled communicators carried by the individuals such as individual 101 moving about the environment. In one embodiment, access points such as the access point 108 are coupled to the host computer 107 through, for example, a wired Ethernet connection via a cable such as a cable 131.

A benefit of having a wireless network connection formed in the environment where the plurality of portable wireless communicators and the host computer 107 are networked for certain applications may be that the system 100 enables individuals to track the positions of others in the group in real time anywhere in the environment where a wireless network is available. This may occur by having, location information about a group of individuals in the environment communicated to the portable wireless communicators such as the communicator 102 from the host computer 107 via the wireless network connection operating within the environment.

In operation, if an individual such as the individual 111 desires to determine the location of another individual of his or her group such as the individual 101, the individual 111 may send a request from his or her portable wireless communicator 110 over the wireless network via the access point 109 to the host computer 107. Host computer 107 may then determine the long range tag identifier for the portable wireless communicator 110 associated with the individual 111 via an internal database, or may determine the identity of the communicator as part of the wireless communication between the communicator and the access point 109.

The host computer 107 may send the location information of the individual 101 or the entire group of individuals to the requesting individual 111 for display on his or her portable wireless communicator 110. The location information for the individual 101 may be in the form of a map or other direction information, to identify the location of the individual or individuals of the group as, for example, displaying an icon representing the individuals as being superimposed on a map of the defined environment, as hereinafter described in more detail.

In an embodiment of the present invention and referencing FIG. 1, the plurality of cell controllers such as cell controller 106 are connected to the host computer 107 through an Ethernet connection or other suitable connection via an Ethernet or other cable such as a cable 125. However, other connectivity options may be used such as a serial or parallel connection. A wireless connection between the cell controllers and the host computer utilizing the access points such as the access point 108 may also be used. The monitoring sites such as the monitoring site 105 are also coupled to the cell controller such as the cell controller 106 via a cable 130.

In another embodiment of the present invention with reference to FIG. 1, the portable wireless communicators such as the communicator 102 may further include a short range passive component (not shown). This short range passive component may be a radio frequency identification tag which is capable of responding to a radio signal such as radio signal 116 by communicating a unique short range tag identifier via a return radio signal (not shown). The short range component may be a part of the external tag such as the tag 135, or either the long range or the short range tag may be incorporated internally within its communicator. Such short range tag may be similar to the one disclosed in U.S. Pat. No. 6,747,562. This short range passive component enables a number of features to be employed by the system 100 including cashless transactions and attraction reservations as described hereinafter.

To enable such functionality, a plurality of reservation stations such as a reservation station 114 are dispersed about the environment for receiving short range tag identifiers from the short range passive components associated with the portable wireless communicators such as the wireless communicator 112 carried by an individual such as the individual 113. Similar to the long range identification tags described previously, the short range tag identifiers of each portable wireless communicator may be unique and correlated in the host computer 107 to a specific individual in a database or other.

The reservation stations may be strategically placed within the environment near vending areas and attraction areas so that individuals may purchase goods and services by presenting their portable wireless communicators to the reservation station such as the reservation station 114. In addition, a reservation for a specific attraction may be made by presenting the portable wireless communicator of an individual to a reservation station, such as reservation station 114, and placed in proximity to the attraction where a reservation is desired to be made to identify the guest.

In operation, as a guest such as the individual 113 enters the reception zone of the reservation station 114, the short range passive component of the tag transmits a short range tag identifier (not shown) to the reservation station 114. The short range tag identifier is then communicated via a cell controller 123, if employed, to the host computer 107 where it is subsequently processed for various applications such as the types hereinafter described.

The host computer 107 according to certain embodiments may include a user account correlated to an individual, such as the individual 113 via the short range passive component of the tag associated with the individual's communicator 112. The user account residing on the host computer 107 may be created by an employee of the environment, such as a theme park employee (not shown) as the individual 113 enters into the park and receives their wireless communication device. The user account may store information regarding cashless funds available for purchasing goods and services by the individual, such as the individual 113. Cashless funds may be created in the individual's user account when the individual, such as the individual 113, deposits money with an employee of the environment or a credit or debit card is used. With cashless funds, an individual, such as the individual 113 may purchase as assortment of goods and/or services. For example, in a theme park environment, the individual may be able to purchase food or tickets to various attractions. The individual may also purchase various services, such as an attraction or transportation. As the individual, such as the individual 113, purchases goods or services, his or her user account residing in the host computer 107 containing cashless funds would be debited or reduced in value.

In operation, an individual, such as the individual 113, desiring to purchase goods or a service, such as an attraction service, may walk over to the location in the environment where the attraction services are being offered. The reservation station 114 may have been positioned in proximity to that attraction. To purchase the amenity service, the individual 113 may present his or her wireless communicator 112 near the reservation station 114 where the reservation station may then read the short range tag identifier from the short range passive component of the tag as heretofore described. The short range tag identification may then be communicated via a cell controller 123 to the host computer 107 for processing. If desired, the host computer 107 may debit the user's account by the cost of the service. The service may then be provided for the individual 113.

In yet another embodiment of the present invention, an individual, such as the individual 113, desiring to make a reservation for a particular attraction in the environment, may walk up to any reservations station, such as the reservation station 114, that may not have been previously placed in proximity to a particular attraction. To make a reservation on the attraction (not shown), the individual, such as individual 113, may present his or her wireless communicator 112 near the reservation station 114. The reservation station 114 would read the short range tag identifier from the wireless communicator device 112. The short range tag identifier correlated to the user 113 may be sent via the cell controller 123 to the host computer 107 for subsequent processing. The host computer 107 may search a data base which may contain information regarding reservations of the specific requested attraction. The next available time the attraction may be utilized by the individual 113 may be reserved via the host computer 107 and communicated to the individual 113 via his or her wireless communicator.

In still another embodiment of the present invention, verification that a particular individual actually had a reservation for the particular attraction at the particular time and date could be performed. This would be accomplished in a similar manner as described in connection with making a reservation by placing a reservation station 114 in proximity to the attraction (not shown).

In one embodiment of the present invention, all individuals, such as the individual 113, entering into an attraction and being verified by the reservation station 114, may have their access to the particular attraction noted and archived by the host computer 107 for subsequent processing by the host computer or employees of the environment. This information may be used for subsequent marketing activities or for security purposes.

Considering now the wireless communication device 110 in greater detail with reference to FIG. 2, a portable computer 132 is provided of conventional design that includes a micro processor (not shown), memory (not shown) and other typical components forming such a device as is well known in the art. Examples of such devices include smart phones, portable digital assistance (PDAs) such as the HP iPAQ PDA, and others. The portable computer 132 further includes a touch screen display 145 of conventional design that is capable of displaying a gray scale or color image thereon. The touch screen 145 may be activated by suitable means such as a stylus (not shown) for processing by the portable computer 132. Other input devices, such as keyboards or others, may also be employed. The wireless communicator 110 further includes a selection button 150 for interacting with suitable software operating on the portable computer 132. The wireless communication device 110 also includes cursor control buttons 155 for controlling and interfacing software operating on the portable computer 132.

The wireless communication device 110 further includes a wireless network radio (not shown) and a wireless networking antenna (not shown). The wireless network radio and antenna are used to communicate over a suitable bidirectional wireless network via the access points, such as the access point 108 (FIG. 1). The wireless network radio may be of a conventional design incorporating WI-FI, or other wireless network radio systems as described previously.

The wireless communicator includes its long range and short range identification tags disposed within the component module or tag 135 mounted externally on the wireless communicator housing 136. The module 135 may also be disposed internally of the housing 136.

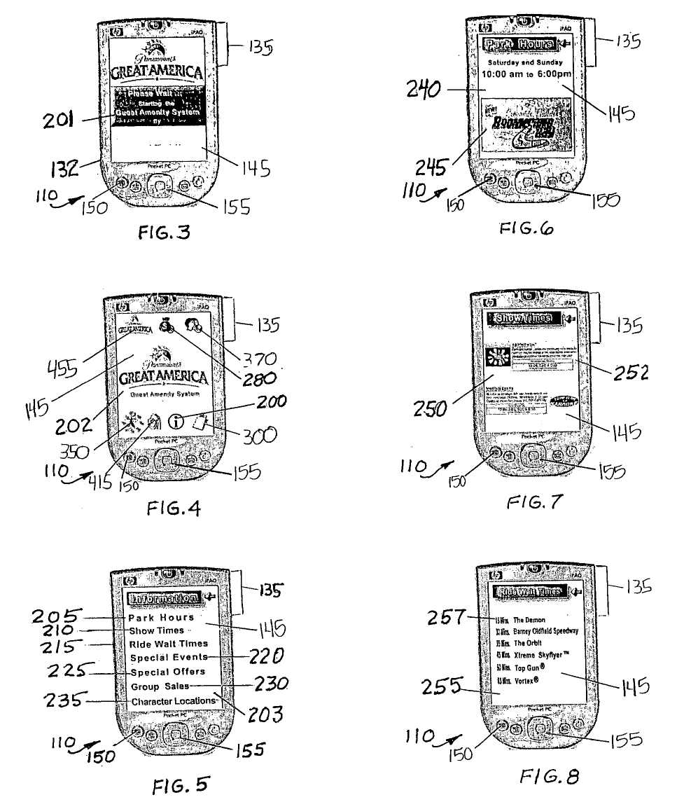

Considering now the portable wireless communicator 110 in greater detail with reference to FIGS. 3 through 38, the portable wireless communicator 110 is shown with a number of screens for interfacing to the individual, such as the individual 111, for performing methods of various embodiments of the invention relating to guest amenity services.

As shown in FIG. 3, a portable wireless communicator 110 is shown wherein the touch screen display 145 shows an Initialization Screen which is presented to the user when the portable wireless communicator 110 is first activated.

As shown in FIG. 4, a portable wireless communicator 110 is shown where the touch screen 145 shows a Home Screen. The Home Screen contains a plurality of graphical user interfaces (GUI) or icons, each containing links to other screens which will be described hereinafter. These icons include an Information icon 200, a Home Screen icon 202, a Cashless Account icon 280, a Group Reservations icon 300, a Locate Individuals of the Group icon 350, a Guest Messages icon 370, a Guest Amenity icon 415, and an Entertainment icon 455.

The various icons described heretofore may be selected by taking a stylus (not shown) and tapping on the touch screen 145 in the location where the icon is located, or by otherwise making a selection by other suitable means such as a mouse or a keyboard. Alternatively, cursor control buttons 155 may be utilized to position a cursor (not shown) on the touch screen 145 over the desired icon and then the button 150 may be depressed to select the desired icon and its associated link.

With reference now to FIG. 5, the portable wireless communicator 110 is shown where the touch screen 145 shows an Information Home Screen. The Information Home Screen contains a plurality of links to other screens which will be described herein below, including a Park Hours link 205, a Show Times link 210, a Ride Wait Times link 215, a Special Events link 220, a Special Offers link 225, a Group Sales link 230, and a Character Locations link 235. These links may be selected using the method described heretofore where a stylus may be positioned over the desired link and pressed onto the touch screen 145. Alternatively, the cursor control buttons 155 may be used to position the cursor over the desired link and button 150 may then be depressed to select that link, or other suitable input devices may be employed.

With reference now to FIG. 6, the portable wireless communicator 110 is shown with the touch screen displaying the Park Hours screen 240. The Park Hours screen may display the hours of operation for the environment in which the system 110 is operating. In this particular embodiment, the environment is a theme park and the hours of operation of the theme park may be shown to be between 10 a.m. and 6 p.m. An advertisement 245 may also be shown on the Park Hours screen 240 so that the theme park operators may generate additional revenue by selling advertisement on the screen viewable by the individuals moving about the theme park and utilizing the portable wireless communicators.

As shown in FIG. 7, a portable wireless communicator 110 is shown with a Show Time screen 250, containing one or more show times 252 that may be playing within the theme park. More information on the individual shows may be conveyed to the individual by touching the touch screen 145 over the area where the shown time 252 is displayed or by using the cursor control buttons 155 with the selection button 150, or by other suitable input means.

As shown in FIG. 8, the portable wireless communicator 110 is shown with the touch screen 145 displaying a Ride Wait Times screen. This screen may be displayed when the Ride Wait Times link 215 (FIG. 5) was selected. The Ride Wait Time screen 255 may include the display of one or more current wait times for various rides within the theme park. For example, the Demon has a ride wait time of 15 minutes as shown at 257.

As shown in FIG. 9, the touch screen 145 of the portable wireless communicator 110 is displaying a Special Events screen 260 which may show any special events or functions that may be occurring within the theme park, either currently or in the future. The Special Events screen 260 is presented after the Special Events link 220 (FIG. 5) was selected.

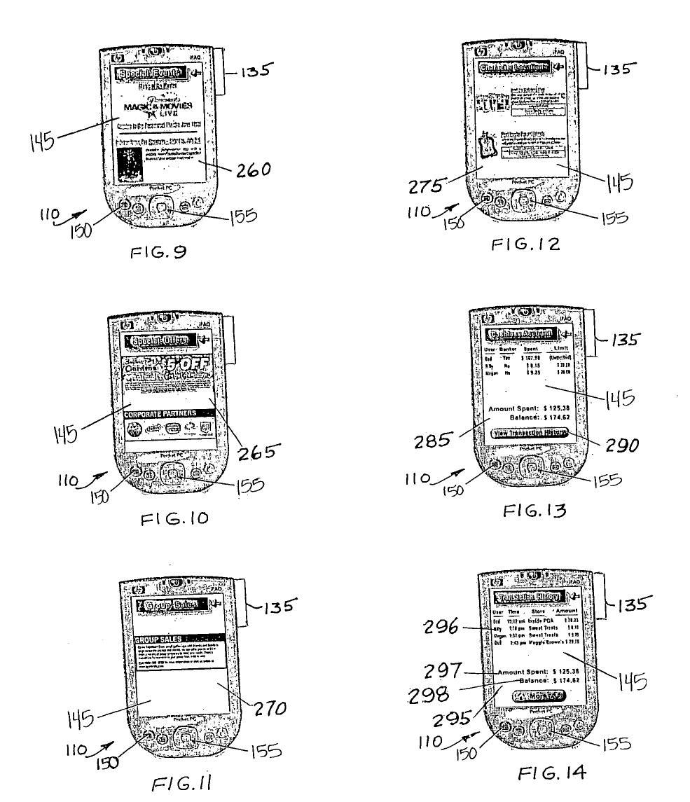

As shown in FIG. 10, the touch screen 145 of the portable wireless communicator 110 displays a Special Offers screen 265, which may be displayed after the Special Offers link 225 (FIG. 5) has been selected by the individual. The Special Offers screen 265 may display any promotional programs that the theme park may be offering to its guests, such as the individual 101.

As shown in FIG. 11, the touch screen 145 of the portable wireless communicator 102 displays a Group Sales screen 270 when the Group Sales link 230 (FIG. 5) was selected by the individual guest, such as the individual 101. The Group Sales screen may convey group sales purchasing information to individuals of a group which may be of interest to groups for discounted tickets or other discounted admissions to various functions in the theme park.

With reference now to FIG. 12, a touch screen 145 of the wireless portable communicator 110 displays a Character Locations screen. The Character Location screen 275 may be displayed after the Character Locations link 235 (FIG. 5) is selected. The Character Location screen 275 may convey to the individual the current location of all characters within the theme park. For example, if the individual wished to see a specific character, such as Mickey Mouse®, the current location of that character may be conveyed on that Character Location screen 275. The information could be conveyed either textually or graphically, such as on a map of the environment.

As shown in FIG. 13, a touch screen 145 of the portable wireless communicator 110 is shown displaying a Cashless Account screen 285. The Cashless Account screen 285 may be displayed on the touch screen display 145 after the Cashless Account icon 280 (FIG. 4) is selected. The Cashless Account screen 285 may display the current balance of the individual's cashless account. A View Transaction History link 290 may be provided on the Cashless Account screen so that additional information about transactions performed by the individual or other individuals of the group may be presented. The View Transaction History link may be selected using a stylus with the touch screen 145 or using the cursor control buttons 155 and the selection button 150, as described heretofore.

With reference now to FIG. 14, a touch screen 145 of the portable wireless communicator 110 is shown displaying a Transaction History screen 295. The Transaction History screen 295 may be displayed on the touch screen 145 when the View Transaction History link 290 (FIG. 13) has been selected. The Transaction History screen 295 may display all of the transactions occurring by the individual or other individuals of the group, which may include ones performed using the short range passive component of the module 135. For example, transaction 296 depicting sweet treats for $8.15 purchased by Billy at 1:10 p.m. may be shown on the Transaction History screen 295. The total amount spent shown at 297 and the remaining cashless funds balance remaining in the user account may also be displayed 298.

As shown in FIG. 15, the touch screen 145 of the portable wireless communicator 110 displays a Group Reservation screen 305. Group Reservation screen 305 may be displayed on the touch screen 145 after the Group Reservations icon 300 (FIG. 4) is selected. The Group Reservations screen 305 may include a display of various reservations that have been reserved by individuals of the group. For example, a reservation by dad at 1:45 p.m. for the Orbit may, for example, be shown on the Group Reservation screen 305 shown at 306. The Group Reservation screen 305 may further include a Make Reservations link 310 and a Plan My Day link 315, which are described herein below.

Referring now to FIG. 16, the touch screen 145 of the portable wireless communicator 110 displays a Plan My Day screen 320, which is displayed on the touch screen 145 after the Plan My Day link 315 (FIG. 15) is selected. The Plan My Day screen 320 may include a Thrill Ride Plan link 325, a Toddler's Day Plan link 330, a Shows Day Plan link 335, and a Make My Own Plan link 340 as examples. Any of the links on the Plan My Day screen 320 may be selected via a stylus (not shown) or through the cursor control buttons and the selector button 150, or other suitable techniques.

Referring now to FIG. 17, the touch screen 145 of the portable wireless communicator 110 displays a Thrill Ride Day plan screen 345 when the Thrill Ride Day Plan link 325 (FIG. 16) is selected. The Thrill Ride Day Plan screen 345 may display a proposed plan of rides for an individual, such as dad, to attend at various time of the day. The Plan may be accepted by the individual by selecting the Accept Plan link 347.

As shown in FIG. 18, the touch screen 145 of the portable wireless communicator 110 displays a Locate Individuals of the Group screen 355. The Locate Individuals of the Group screen 355 may be displayed on the touch screen 145 when the Locate Individuals of the Group icon 350 (FIG. 4) is selected. The Locate Individuals of the Group screen 355 may graphically display the position of other individuals of the group over a map of the environment. For example, the locations of dad, Billy, and Megan may be shown as icons superimposed over a map where the icon for dad 356 is shown over the map. The icon for Billy 357 may be shown below and to the left of the icon for dad 356, and the icon for Megan 358 may be shown below and to the right of the icon for dad 356.

As shown in FIG. 19, the touch screen 145 of the portable wireless communicator 110 is shown displaying a Shortest Route Calculation screen 360. On this screen, a shortest route may be calculated between two individuals selected by the user of the portable wireless communicator 110. In operation, an individual may tap his or her stylus on the icon of another individual to which they wish to travel, or otherwise activate the desired icon by other suitable input techniques. Thus, if dad, for example, as the user of the portable wireless communicator 110, wished to determine the shortest route to visit his son Billy, he may tap his stylus on the icon for Billy 357. The host computer 107 (FIG. 1) may receive this information from the portable wireless communicator 110 via the wireless network and communicate back to the portable wireless communicator 110 graphical information conveying the shortest route in the environment for dad. This may be shown graphically as a plurality of icons on the touch screen 145 such as icon 356 representing dad to travel to Billy, where Billy is shown as an icon 357 on the touch screen 145. In this way, dad may become aware of the shortest route for him to travel to Billy. The shortest route may be displayed as a line 359.

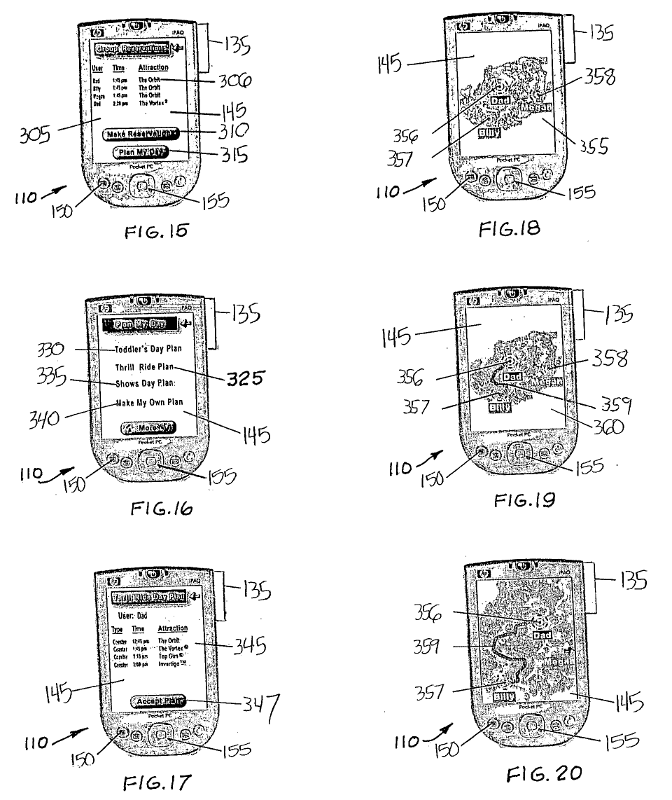

Referring now to FIG. 20, the touch screen 145 of the portable wireless communicator 110 displays a Magnifying Shortest Route Calculation screen of screen 360 (FIG. 19) where the icon for dad 356, the icon for Billy 357, and the shortest route 359 may be graphically displayed in a magnified format. Thus, more detail may be provided to dad in how to navigate the environment to travel to Billy.

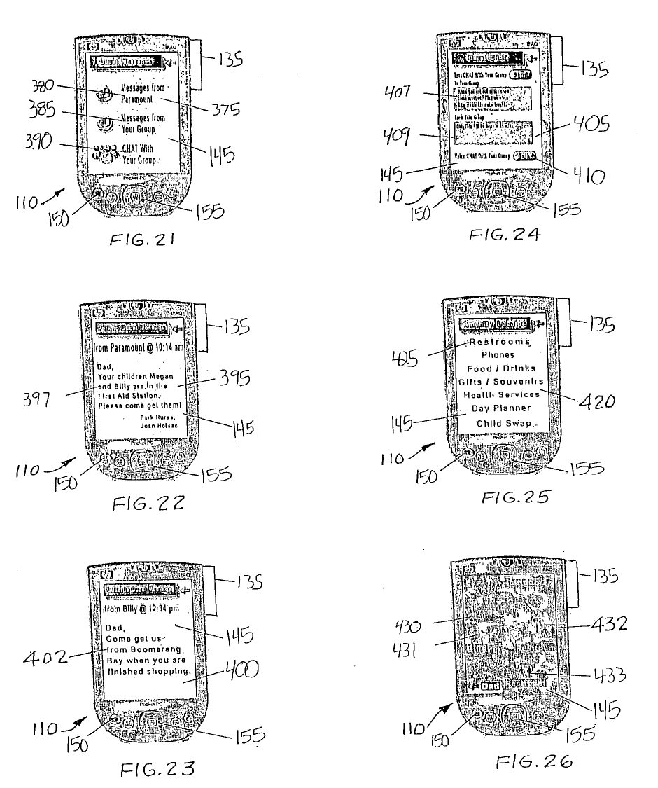

Referring now to FIG. 21, the touch screen 145 of the portable wireless communicator 110 displays a Guest Messages screen 375, which is displayed after the Guest Messages icon 370 (FIG. 4) is selected. The Guest Messages screen 375 includes a Park To Guest message link 380, a Guest To Guest Message link 385, and a Guest Chat link 390. These links may be selected using the method as described heretofore by using the stylus (not shown) or the cursor control buttons 155 and the selection button 150, or other suitable input techniques.

As shown in FIG. 22, the touch screen 145 of the portable wireless communicator 110 displays a Park To Guest Message screen 395 when the Park To Guest Message link 380 (FIG. 21) has been selected. The Park To Guest Message screen 395 may display messages from the theme park to various individuals possessing portable wireless communicators 110. The Park To Guest Message screen 395 includes a message typically displayed in textual format shown at 397.

As shown in FIG. 23, the touch screen 145 of the portable wireless communicator 110 displays a Guest To Guest Message screen after the Guest To Guest Message link 385 (FIG. 21) has been selected. The Guest To Guest Message screen 400 may display a message sent from one individual, such as individual 101 (FIG. 1) to individual 111 (FIG. 1). The message may be typically displayed in textual format shown at 402.

As shown in FIG. 24, a Guest Chat screen is displayed on the touch screen 145 of the portable wireless communicator 110 after the Guest Chat link 390 (FIG. 21) has been selected. The Guest Chat screen may permit dynamic communications to occur between various individuals, such as the individual 101 (FIG. 1) and the individual 113 (FIG. 1). Messages, alternatively, may be sent to the entire group. Messages may be sent to either an individual or the entire group by typing or otherwise inputting a message into the Chat Message Box to Group window 407. Messages received from the group may be displayed in the Chat Message Box From Group 409. Messages may be typed into the Chat Message Box To Group window 407 by using an on-screen keyboard in conjunction with a stylus (not shown) or by other suitable techniques.

Alternatively, messages may be sent to the group using the Voice Chat link 410 by depressing the Voice Chat link 410 using the stylus or the cursor control buttons and the selection button 150. Voice communications may be transmitted from the portable wireless communicator 110 to other portable wireless communicators in possession by other individuals within the group. Communication may be performed by utilizing the portable wireless communicator's internal microphone (not shown) and speaker (not shown). Voice-over IP may be employed over the wireless network connection if the wireless network connection uses Ethernet technology and TCP/IP protocol, or other suitable techniques may be employed. Alternatively, other means for communicating voice over the wireless network may be employed, as is well known in the art.

As shown in FIG. 25, a Guest Amenity Locator screen 420 is displayed on the touch screen 145 of the portable wireless communicator 110. The Guest Amenity Locator screen 420 is displayed on the touch screen 145 after the Guest Amenity Locator icon 415 (FIG. 4) is selected. The Guest Amenity Locator screen may contain links for a plurality of amenities to be located relative to the positions of individuals of the group. For example, a link for Restrooms 425 may be shown, as well as links for Phones, Food/Drinks, Gifts/Souvenirs, Health Services, Day Planner, and Child Swap.

As shown in FIG. 26, a Restrooms screen 430 is displayed on the touch screen 145 of the portable wireless communicator 410 after the Restrooms link 425 (FIG. 25) has been selected. The Restroom screen may display a graphical representation of the environment, such as a theme park, with the relative positions of individuals displayed as icons. The icons of the individuals are displayed in relation to various amenities, such restrooms, in the environment. For example, the icon for Billy 431 may be displayed on the left side of the touch screen and the icon for a restroom 432 may be displayed on the right side of the screen, indicating that Billy is to the left of the restrooms 432. Another restroom 433 may also be displayed on the touch screen 145 below and to the right of Billy. Thus, Billy would know immediately where two restrooms were in relation to his current position.

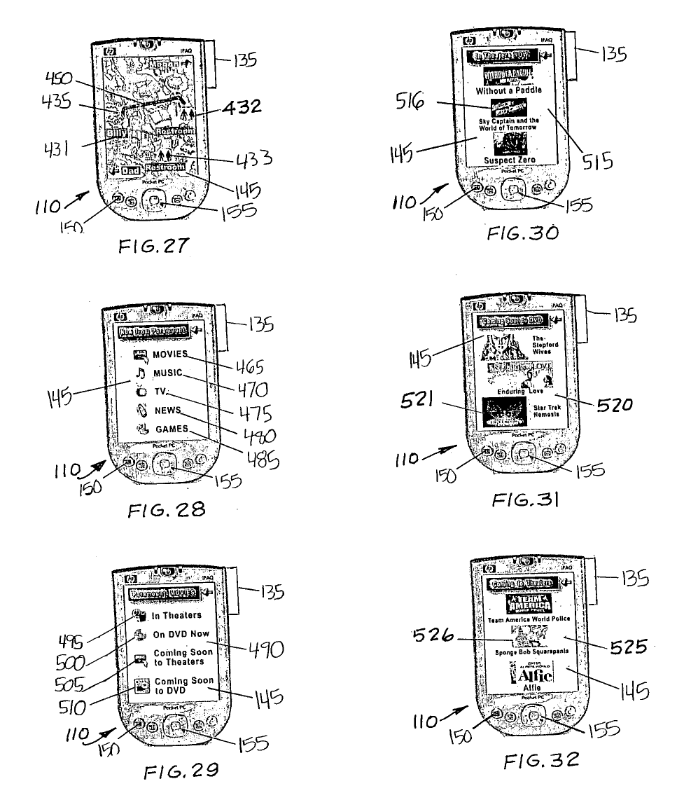

As shown in FIG. 27, a Restrooms Shortest Route screen 435 is displayed on the touch screen 145 of the portable wireless communicator 110. The Restrooms Shortest Route screen 435 is similar to the Restrooms screen 430 (FIG. 26) except a shortest route may be selected between an individual, such as Billy shown at icon 435, and an environment amenity, such as restroom 432. The shortest route between the current user, such as Billy, and a chose amenity, such as restroom 432, may be determined and displayed on the touch screen 145 as described above in conjunction with the Shortest Route Calculation screen 360 (FIG. 19) hereinabove. The shortest route may typically be computed by the host computer 107 (FIG. 1).

As shown in FIG. 28, an Entertainment Menu screen 460 is shown on the touch screen 145 of the portable wireless communicator 110. The Entertainment menu screen 460 may be displayed on the touch screen 145 after the Entertainment icon 455 (FIG. 4) is selected. The Entertainment menu screen 460 may include a Movies link 465, a Music link 470, a T.V. link 475, a News link 480, and a Games link 485. These links may be selected using the stylus (not shown) or the cursor control buttons 155 and the selection button 150 as described heretofore, as well as by other suitable techniques.

With reference to FIG. 29, a Movies screen 490 is displayed on the touch screen 145 of the portable wireless communicator 110 after the Movies link 465 (FIG. 28) has been selected. The Movie screen 490 may contain a plurality of links, including an In Theaters link 495, an On DVD Now link 500, a Coming Soon to Theaters link 505, and a Coming Soon to DVD link 510. These links may be selected as described heretofore and are described in more detail herein below.

Referring now to FIG. 30, an In Theater screen 515 is displayed on the touch screen 145 of the portable wireless communicator 110 after the In Theaters link 495 (FIG. 29) has been selected. The In Theaters Now screen 515 may convey to individuals current movies that are being played in theaters, such as movie feature “Sky Captain and the World of Tomorrow” shown at 516.

Referring now to FIG. 31, the touch screen 145 displays a Coming Soon to Theaters screen 525 when the Coming Soon to Theaters link 505 (FIG. 29) is selected. The Coming Soon to Theaters screen 525 may display movies that will be coming soon to DVD, such as movie 521 “Star Trek Nemesis.”

Referring now to FIG. 32, a Coming Soon to Theaters screen 525 is displayed on touch screen 145 of the portable wireless communicator 110 when the Coming Soon to Theaters link 505 (FIG. 29) is selected. This screen may display various movie features, such as movie feature 526 “Sponge Bob Square Pants” that may be arriving at theaters in the near future.

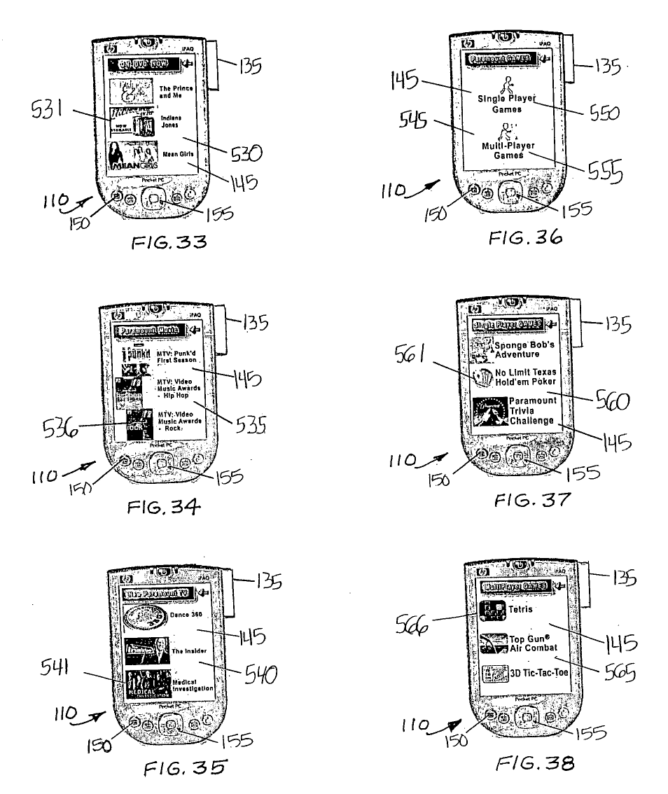

Referring now to FIG. 33, the touch screen 145 of the portable wireless communicator 110 displays an On DVD Now screen 530 when the On DVD Now link 500 (FIG. 29) is selected. This screen displays movies that are available on DVD at the present time, such as movie feature 531 “Indiana Jones.”

As shown in FIG. 34, the touch screen 145 of the portable wireless communicator 110 displays Music screen 535 when Music link 470 (FIG. 28) has been selected. The Music screen 535 may display current music that may be available from one or more music providers or distributors, such as music title “MTV: Video Music Awards—Rock” shown at 536.

As shown in FIG. 35, the touch screen 145 of the portable wireless communicator 110 displays a T.V. screen 540 when the T.V. link 475 (FIG. 28) is selected. This screen may show various television shows that are being promoted by a specific television provider, such as television feature 541 entitled “Medical Investigation.” The title of the T.V. show in a graphical representation of the T.V. show may be provided on the touch screen 145.

As shown in FIG. 36, Games, either Single-Player Games or Multi-Player Games may be played on the portable wireless communicator 110. Thus, screen 145 of the portable wireless communicator 110 may display a Game screen 545 when the Games link 485 (FIG. 28) is selected. Two icons are present on the Games screen 545. The first icon may be a Single-Player Games link 550 and a Multi-Player Games link 555. Thus, if Single-Player Games may be desired to be played, the Single-Player Games link 550 may be selected using the methods described hereinabove. Likewise, if Multi-Player Games may be desired to be played, the Multi-Player Games link 555 may be selected using the methods described hereinabove.

With reference FIG. 37, the touch screen 145 of the portable wireless communicator 110 displays a Single-Player Games screen 560 when the Single-Player Games link 550 (FIG. 36) has been selected. Thus a Single-Player Game such as single-player game 561 entitled “No Limit Texas Hold 'Em Poker” may be selected using the methods described herein above, and the game may then be subsequently played.

As shown in FIG. 38, the display 145 of the portable wireless communicator 110 displays a Multi-Player Game screen 565 when the Multi-Player Games link 555 (FIG. 36) has been selected. The Multi-Player Games screen 565 displays a plurality of links to various multi-player games, such as multi-player game 566 entitled “Tetras.” After this link is selected using the methods described hereinabove, the multi-player game may be played with other players (i.e., individuals). For example, individual 101 (FIG. 1) may desire to play a game with individual 111 (FIG. 2) each having portable wireless communicators. This may be accomplished by both individuals 101 and 111 choosing the same multi-player game, such as multi-player game 566 entitled “Tetras.” The game may be played over the wireless network via the access points, such as access point 108 (FIG. 1) using conventional methods as well known in the art.

While particular embodiments of the present invention have been disclosed, it is to be understood that various different modifications are possible and are contemplated within the true spirit and scope of the appended claims. For example, positional information of individuals within the environment may be provided by global position satellite (GPS) techniques. There is no intention, therefore, of limitations to the exact abstract or disclosure herein presented.

What is claimed is:

1. A method for providing guest amenities for a defined environment, comprising:
providing each one of at least some of the individuals of a group with a wireless enabled portable communicator having an identification tag with a unique identification tag identifier, the tag having means for receiving signals and for sending signals including the identification tag identifier;
locating at least one monitoring site within the environment for sending and receiving signals to and from the tags as the individuals move within the defined environment;
determining location information for the individuals in response to the monitoring sites;
sending location information about the group of individuals within the environment to at least one of the portable wireless communicators; and
communicating with the portable wireless communicator regarding other amenity information.

2. A method as described in claim 1, wherein the portable wireless communicator includes a graphical user interface.

3. A method as described in claim 2, wherein the graphical user interface includes a touch screen.

4. A method according to claim 1, wherein the portable wireless device further includes at least one control button for controlling the operation thereof.

5. A method as described in claim 1, wherein the environment is one selected from the group consisting of parks, casinos, hotels, cruise ships, department stores, residential communities, zoos, resorts and shopping malls.

6. A method as described in claim 1, further including providing at least one access point and a host computer for providing wireless connectivity and bidirectional communications capability to portable wireless communicators in the environment.

7. A method as described in claim 6, wherein the communicating location information about the group of individuals in the environment from the host computer to the portable wireless communicator via the wireless network connection occurs via the access points.

8. A method according to claim 1, wherein the portable wireless communicator further includes a second identification tag having a second identification tag identifier, the second identification tag having means for receiving a radio signal and for responding to that signal with a radio signal that includes the second identification tag identifier.

9. A method according to claim 8, further including:
locating one or more cell controllers throughout the environment having radio transmission and receiving means for sending and receiving a radio signal via one or more registration sites, each registration site having an antenna for sending and receiving the signals; and
receiving the second identification tag identifier via the host computer.

10. A method according to claim 9, further including using the received second identification tag identifier for identifying and adding an individual to a group and recording the added individual of the group via the host computer.

11. A method according to claim 9, further including creating a user account for the recorded individual of the group for storing information regarding cashless funds available for purchasing goods and services.

12. A method according to claim 11, further including debiting the user account upon an individual of the group purchasing goods and services and upon receiving the second identification tag identifier via the host computer identifying the individual of the group purchasing the goods and services.

13. A method according to claim 9, further including providing a registration site in proximity to a vending location for goods or services.

14. A method according to claim 9, further including providing a registration site in proximity to an attraction.

15. A method according to claim 9, further including receiving a selected attraction by an individual of the group from the portable wireless communicator and making a reservation for the selected attraction for that individual.

16. A method according to claim 15, further including verifying that a reservation exists for the individual checking into an attraction via the received second identification tag number.

17. A method according to claim 16, further including archiving the second identification tag numbers from individuals checking into attractions.

18. A method according to claim 14, further including correlating the received second identification tag identifier of an individual of the group to the registration site in proximity to the selected attraction for creating a reservation for that attraction for that individual.

19. A method according to claim 8, wherein the first and second identification tag identifiers are the same.

20. A method according to claim 1, further including communicating available attractions to the portable wireless communicator.

21. A method as described in claim 1, further including displaying an Information Home Screen on the portable wireless communicator.

22. A method as described in claim 21, wherein the Information Home Screen further includes a Park Hours link, a Show Times link, a Ride Wait Times link, a Special Events link, a Special Offers link, a Group Sales link, and a Character Locations link.

23. A method as described in claim 1, further including displaying a Park Hours screen.

24. A method as described in claim 23, wherein the Park Hours screen further includes a Show Times link.

25. A method as described in claim 1, further including displaying a Show Times screen.

26. A method as described in claim 1, further including displaying a Ride Wait Times screen.

27. A method as described in claim 1, further including displaying a Special Events screen.

28. A method as described in claim 1, further including displaying a Special Offers screen.

29. A method as described in claim 1, further including displaying a Group Sales screen.

30. A method as described in claim 1, further including displaying a Character Location screen.

31. A method as described in claim 1, further including displaying a Cashless Account screen.

32. A method as described in claim 31, wherein the Cashless Account screen further includes a View Transaction History link.

33. A method as described in claim 1, further including displaying a Transaction History screen.

34. A method as described in claim 33, wherein the Transaction History screen further includes displaying an Amount Spent and a Remaining Balance.

35. A method as described in claim 1, further including displaying a Group Reservations screen.

36. A method as described in claim 35, wherein the Group Reservations screen further includes a Make Reservations link and a Plan My Day link.

37. A method as described in claim 1, further including displaying a Plan My Day screen.

38. A method as described in claim 37, wherein the Plan My Day screen further includes a Thrill Ride Day Plan link, a Toddler's Day Plan link, a Shows Day Plan link, and a Make My Own Plan link.

39. A method as described in claim 1, further including displaying a Thrill Ride Day Plan screen.

40. A method as described in claim 1, further including displaying a Locate Individuals of the Group screen.

41. A method as described in claim 1, further including displaying a Shortest Route Calculation screen.

42. A method as described in claim 1, further including displaying a Magnified Shortest Route Calculation screen.

43. A method as recited in claim 42, wherein the Magnified Shortest Route Calculation screen further includes at least one icon for an individual of the group and a depiction of a shortest route.

44. A method as recited in claim 1, further including displaying a Guest Messages screen.

45. A method as described in claim 44, wherein the Guest Messages screen further includes a Park To Guest Message link, a Guest To Guest Message link, and a Guest Chat link.

46. A method as described in claim 1, further including displaying a Park To Guest Message screen.

47. A method as described in claim 1, further including displaying a Guest To Guest Message screen.

48. A method as described in claim 1, further including displaying a Guest Chat screen.

49. A method as described in claim 48, wherein the Guest Chat screen further includes a Voice Chat link, a Chat Message Box to Group, and a Chat Message Box From Group.

50. A method as described in claim 1, further including displaying a Guest Amenity Locator screen.

51. A method as described in claim 50, wherein the Guest Amenity Locator screen further includes a Restrooms link.

52. A method as described in claim 1, further including displaying a Restrooms screen.

53. A method as described in claim 52, wherein the Restrooms screen further includes at least one icon for at least an individual of the group and at least one icon for at least one restroom in the environment.

54. A method as described in claim 1, further including displaying a Restrooms Shortest Route screen.

55. A method as recited in claim 54, wherein the Restrooms Shortest Route screen further includes at least one icon for at least one individual of the group, at lease one icon for at least one restroom in the environment, and a depiction of the shortest route.

56. A method as recited in claim 1, further including displaying an Entertainment Menu screen.

57. A method as recited in claim 56, wherein the Entertainment Menu screen further includes a Movies link, a Music link, a T.V. link, a News link, and a Games link.

58. A method as described in claim 1, further including displaying a Movies screen.

59. A method as described in claim 58, wherein the Movies screen further includes an In Theaters link, an On DVD Now link, a Coming Soon to Theaters link, and a Coming Soon to DVD link.

60. A method as described in claim 1, further including displaying an In Theaters Now screen.

61. A method as recited in claim 1, further including displaying a Coming Soon to DVD screen.

62. A method as described in claim 1, further including displaying a Coming Soon to Theaters screen.

63. A method as described in claim 1, further including displaying an On DVD Now screen.

64. A method as described in claim 1, further including displaying a Music screen.

65. A method as described in claim 1, further including displaying a T.V. screen.

66. A method as described in claim 1, further including displaying a Games screen.

67. A method as recited in claim 66, wherein the Games screen further includes a Single-Player Games link and a Multi-Player Games link.

68. A method as recited in claim 1, further including displaying a Single-Player Games screen.

69. A method as described in claim 1, further including displaying a Multi-Player Games link screen.

70. A method as described in claim 1, further including displaying a Home screen.

71. A method as recited in claim 70, wherein the Home screen further includes a Group Reservation link, a Locate Individuals of the Group link, an Entertainment link, a Home Screen link, a Cashless Account link, a Guest Messages link, and a Guest Amenity link.

72. A user identifier and portable wireless communicator for communicating with a locator system in a defined environment and for providing bidirectional wireless communications between individuals of groups within a defined environment, comprising:
a long range transmitter adapted to transmit an identification signal to one or more readers in the defined environment, the identification signal being associated with a particular user;
a short range passive component having identification information adapted to be read by a locator station;
a portable wireless communications device having the long range transmitter and short range passive component affixed thereto; and
a wireless network radio for communicating bidirectionally over a wireless network.

73. A user identifier and portable wireless communicator as recited in claim 72, wherein the portable wireless communications device further includes a graphical user interface.

74. A user identifier and portable wireless communicator according to claim 73, wherein the graphical user interface includes a touch screen.

75. A user identifier and portable wireless communicator as recited in claim 72, wherein the identification signal includes user information identifying the user.

76. A user identifier and portable wireless communicator according to claim 75, wherein the user information is identical to the identifier information in the short range passive component.

77. A user identifier and portable wireless communicator according to claim 72, wherein the wireless network radio communicates over spread spectrum.

78. A user identifier and portable wireless communicator according to claim 72, wherein the wireless network communicates over a cellular communication system.

79. A user identifier and portable wireless communicator according to claim 72, wherein the wireless network and radio communicates via access points.

80. A user identifier and portable wireless communicator wherein the user and portable wireless communicator further includes a speaker and a microphone.

81. A system for providing guest amenities for a defined environment, comprising:
means for providing each one of at least some of the individuals of a group with a wireless enabled portable communicator having an identification tag with a unique identification tag identifier, the tag having means for receiving signals and for sending signals including the identification tag identifier;
means for locating at least one monitoring site within the environment for sending and receiving signals to and from the tags as the individuals move within the defined environment;
means for determining location information for the individuals in response to the monitoring sites;
means for sending location information about the group of individuals within the environment to at least one of the portable wireless communicators; and
means for communicating with the portable wireless communicator regarding other amenity information.
